(19) United States
(12) Patent Application Publication
(10) Pub. No.: US 2008/0179198 A1
(43) Pub. Date: Jul. 31, 2008

(54) System and method of use for electrochemical measurement of corrosion

(76) Inventors: Michelle S. Burgess, Newport, RI (US); Richard Brown, Wakfield, RI (US)

Correspondence Address: NAVAL UNDERSEA WARFARE CENTER;DIVISION NEWPORT, 1176 HOWELL STREET, CODE 000C, NEWPORT, RI, 02841, US

(21) Appl. No.: 11/698,921

(22) Filed: Jan. 29, 2007

(51) Int. Cl. G01N 17/02; G01N 27/26

(52) U.S. Cl. 205/775.5

(57) ABSTRACT

A system and method of use is provided for using electrochemical impedance spectroscopy to determine the corrosion rates of coupled metals. Two dissimilar metals are coupled together and exposed to a saltwater electrolyte in an electrochemical cell. A variable frequency current is passed through the cell and collected at the coupled metals. The impedance and phase angle of the collected current data are plotted verses frequency. The plotted data are compared to and analogized to a known plot for physical electric circuits. When a matching plot and circuit are found, the corrosion rate data associated with the matched plot are used to determine the corrosion rates of the coupled metals.

### STATEMENT OF GOVERNMENT INTEREST

The invention described herein may be manufactured and used by or for the Government of the United States of America for governmental purposes without the payment of any royalties thereon or therefore.

### BACKGROUND OF THE INVENTION

(1) Field of Invention

The present invention is directed to the use of electrochemical impedance spectroscopy to determine corrosion rates in galvanically coupled systems.

(2) Description of Prior Art

Corrosion of metals is a problem that results in the need for costly maintenance and repairs. This is particularly apparently in harsh environments such as coastal areas and salt-water applications.

In order to determine the effects of corrosion on metals, the metals would be observed over a long period of time in a given corrosive environment. Such experimental systems, however, required experimental times on the order of months or years to yield any useful results.

In order to obtain the desired data on corrosion rates, Electrochemical Impedance Spectroscopy (EIS) has been use. Generally, in an EIS system, an electrochemical cell is created using the material of interest, i.e. the metal and an electrolyte. A current carrying counter-electrodes delivers a small voltage through the electrolyte to the metal, while a reference electrode measures the potential generated between the metal and counter-electrodes. The impedance data and the phase shift between the delivered current and the current at the metal are measured at each frequency and analyzed to determine the corrosion resistance of the metal.

However, in many applications, a single metal is not used. Instead, many structures are used in corrosive environments in which the structures include different metals coupled together. This includes applications where a sacrificial metal is used to control the corrosion rate of another metal. The coupling of these metals together can affect the corrosion rates of both metals. Conventional methods for determining corrosion rates, including methods utilizing EIS, have been applied to single metals but not to multiple metals coupled together.

### SUMMARY OF THE INVENTION

The present invention is directed to a method and system for the use of Electrochemical Impedance Spectroscopy (EIS) to determine corrosion rates in dissimilar metals that are coupled together, including coupled metals that are coated.

In one embodiment, an electrochemical cell is created by electrochemically coupling a sample of the coupled metals, i.e. the working electrode, to a counter-electrode such as a piece of platinum through an electrolyte or electrolytic solution (for example: a salt water solution). A reference electrode is also disposed in the electrolyte, for example a Saturated Calomel Electrode, and is used to measure the open circuit potential between the coupled metals and the counter-electrode. That is, the reference electrode measures the resistance or impedance that is attributable to the electrolyte. A small sinusoidal voltage, for example about 5 mV, is applied to the electrochemical cell through the counter-electrode over a wide frequency range, for example from about 10⁻³ to about 10⁵ Hz.

The current response and phase angle are measured at each voltage increment, and a plot of the log of the impedance and the phase angle versus frequency is used to provide a correlation between capacitance, resistance, and corrosion resistance.

A phase angle of 0° indicates pure capacitance, while a phase angle of 90° indicates pure resistance. Phase angles between 0° and 90° indicate a mixture of resistance and capacitance. The impedance and phase angle versus frequency plot developed for a given pair of coupled metals is compared to known plots for arrangements of physical circuits. Therefore, the impedance behavior of a given coupled metal sample under a corrosive environment, i.e. the electrolyte, is analogized to a known electric circuit containing a given arrangement of resistors and capacitors by matching the graphs associated with the coupled metal and the circuit. Having matched the graphs, i.e. having identified the representative physical circuit, the corrosion rates associated with that physical circuit can be applied the metal couple.

A system and method in accordance with the present invention utilizes an EIS system to determine the corrosion rate of two metals that are galvanically coupled together wherein one of the metals is relatively more cathodic and the other metal is correspondingly relatively more anodic. The coupled metals are measured both uncoated and coated.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings wherein like reference numerals and symbols designate identical and corresponding parts through the view and wherein:

FIG. 1 is a schematic representation of an embodiment of an electrochemical cell for use in the present invention;

FIG. 2 is an illustration for use in the present invention of coupled metals; and

FIG. 3 is an illustration of an embodiment of a physical circuit for use in accordance with the present invention.

### DETAILED DESCRIPTION OF THE INVENTION

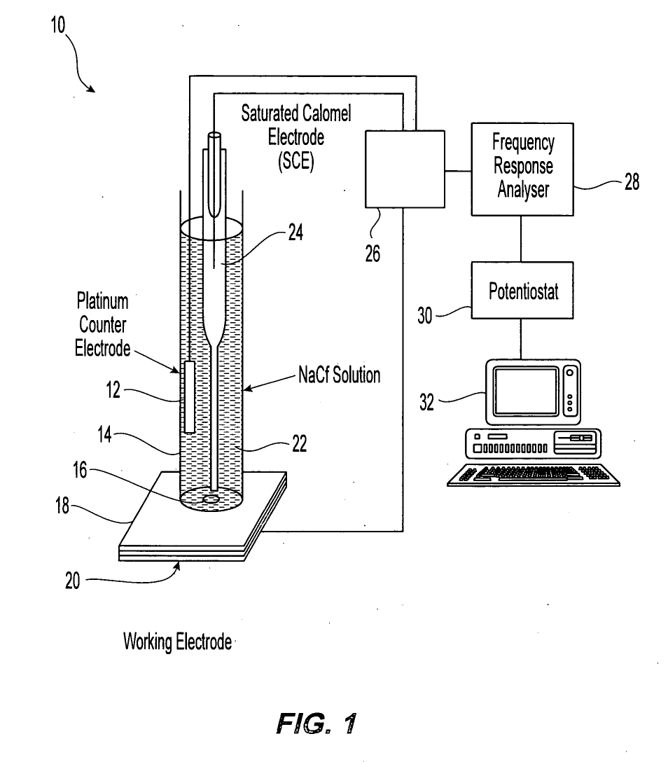

Referring now to FIG. 1, an exemplary embodiment of a system 10 in accordance with the present invention for using Electrochemical Impedance Spectroscopy (EIS) to determine the corrosion rate of both uncoated and coated galvanically coupled metals is illustrated. The system 10 includes an electrochemical cell 14 containing an electrolyte 22 or electrolytic solution. The electrolyte 22 is selected to be able to conduct the desired current to the metals to be tested and to simulate the corrosive environment for the metals. Suitable electrolytes include salt solutions such as sodium chloride (NaCl) solutions, which simulate brackish water or seawater exposure.

In one embodiment, the electrochemical cell 14 contains a 0.5 normal NaCl solution. In contact with the cell 14 and with the electrolyte 22 inside the cell is a working electrode 20 that contains the coupled metals, a first metal 18 and a second metal 16. The metals are selected to be dissimilar such that one metal is relatively more anodic than the other. Both metals are in contact with the electrolyte. Suitable metal couples include, but are not limited to 1020 mild steel and 6061-T6 aluminum, 1020 mild steel and 304 stainless steel and 304 stainless steel and 6061-T6 aluminum.

The coupled metals can be both uncoated and coated. Suitable coatings include, but are not limited to, powder epoxy, glass reinforced epoxy, polyurethane, electroplated aluminum and an aluminum/titanium ceramic.

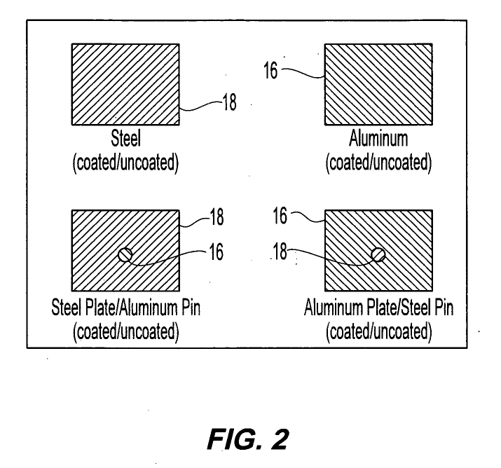

Referring to FIG. 2, the two metals are coupled together by placing one of the metals in an aperture formed in the other metal, for example a circular aperture. The coupled metals can be test with the second metal 16 inserted into an aperture in the first metal 18 or with the first metal inserted into an aperture in the second metal. Although any suitable shapes can be selected for the first and second metals, preferably one metal is arranged as a generally flat plate, for example about 2 inches square and ¼ inch thick, and the second metal is arranged as a cylinder having a generally circular cross-section and a diameter of about ¼ inch. The size of the aperture and hence the surface area of the inserted metal is selected based upon the desired ratio of surface areas of the first and second metal that are in contact with the electrolyte. Preferably, the desired ratio of the surface areas of the metal plate to the metal plug is about 3:1, although other ratios can be used.

Returning again to FIG. 1, the system 10 also includes a counter electrode 12 in contact with the electrolyte 22. Suitable materials for the counter-electrode include platinum, palladium and gold. Preferably, the counter-electrode 12 is platinum. The counter-electrode 12 is capable of delivering a known current to the working electrode through the electrolyte 22.

In order to measure the voltage of the working electrode, a reference electrode 24 is also provided in communication with the electrolyte 22. Suitable reference electrodes include, but are not limited to, saturated calomel electrodes. All three electrodes are in communication with a three-lead potentiostat 30 through an interface device 26 and frequency response analyzer 28. Suitable three-lead potentiostats are known and available in the art.

The potentiostat 30 is in communication with a control mechanism 32, for example a personal computer, to provide control of the potentiostat and analysis of the data received from the potentiostat.

The potentiostat 30 generates a small, sinusoidal voltage, for example about 5 mV, along a wide frequency range. In one embodiment, this frequency band is from about 10⁻³ to about 10⁵ Hz. This voltage is communicated to the counter-electrode 12. The voltage propagates through the electrolyte 22 to the working electrode 24 where it is communicated back to the potentiostat 30 and the computer 32. The known currents generated by the potentiostat 30 and the current received by the working electrode 24 are measured and recorded by the computer 32. In addition, the computer 32 computes the difference between the current and phase angles generated by the potentiostat 30 and those returned by the sample. Current data are collected over time to determine the effect of prolonged exposure and to replicate a steady state condition. The computer 32 then generates a graph or plot of the log of the impedance and the phase angle versus frequency. The generated graph or plot is then compared to known or modeled plots for physical electric circuits to establish a correlation between capacitance, inductance and resistance and to determine the corrosion resistance of the material and the failure mechanism of the coating.

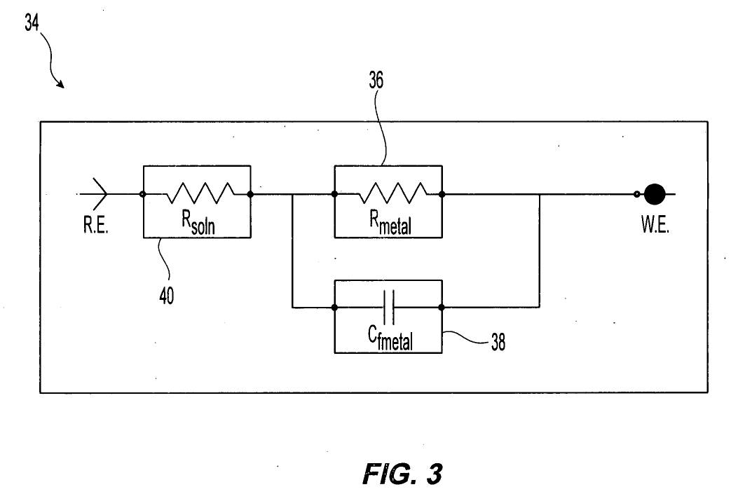

Referring to FIG. 3, one suitable physical electric circuit that can be used as a baseline model for the corrosion determination is the Randle's Circuit 34. Since the coated and uncoated galvanically coupled metals can produce models that are more complex than the Randle's Circuit 34, modifications can be made to this simple circuit to better fit the impedance data. For example, elements such as capacitors, inductors and resistors can be added to the Randle's Circuit 34 to best model each data series.

In one embodiment, model validation is achieved by systematically changing one parameter to determine the response of the system. For example, doubling the solution resistance would cause a uniform shift upward in the model impedance.

In another embodiment, the corrosion mechanism of the coupled metals is determined by measuring the charge transfer resistance (Rₜ) using EIS. When the Rₜ of a material decreases, the corrosion rate increases. As discussed, the Rₜ is determined by modeling the electrochemical system as an electrical circuit, with each circuit element contributing to the system impedance.

In the relatively simple Randle's Circuit 34 illustrated in FIG. 3, the electrochemical interface is a parallel charge transfer resistance (Rₘₑₜₐₗ) 36 with a double layer capacitance (C_{fmetal}) 38 in parallel and the solution resistance of an electrolyte (Rₛₒₗₙ) 40 in series. The corrosion mechanism of the test system is determined by comparing the variation of impedance values of each circuit element over time.

A plot of the log of impedance and the phase angle shift vs. frequency is used to determine the coating failure mode by considering that a phase angle of 0° correlates to pure resistance, and an angle of 90° correlates to pure capacitance. Angles between 0° and 90° correlate to a mixture of capacitance and resistance. A substantial decrease in coating capacitance implies the coating is thinning, which occurs when moisture permeates the coating, reaches the material surface, and corrosion begins.

In the method for determining the corrosion rates of galvanically coupled metals in accordance with exemplary embodiments of the present invention, two dissimilar metals for testing are selected and are coupled together. The dissimilar metals are selected such that one metal is generally more anodic and one metal is generally more cathodic. Preferably, at least one of the first metal and the second metal is substantially more anodic than the other metal. Suitable coupled metal pairs include, but are not limited to, mild steel and aluminum, mild steel and stainless steel and stainless steel and aluminum.

The metals can be coupled together through any suitable method available and known in the art. In one embodiment, the metals are galvanically coupled together.

In another embodiment as shown in FIG. 1, an aperture is formed in the first metal 18 and an appropriate amount of the second metal 16 is placed in the aperture to fill the aperture. For example, as illustrated in FIG. 1 and FIG. 2, the first metal can be generally plated-shaped, and the aperture can have a substantially circular cross-section. In still another embodiment, the coupled metals are further coated using at least one corrosion resistant material. Suitable corrosion resistant materials include, but are not limited to, powder epoxy, glass reinforced epoxy, polyurethane, electroplated aluminum and an aluminum/titanium ceramic.

In accordance with the method of the present invention, electrochemical impedance spectroscopy is used to produce a plot of impedance and phase angle verses frequency for the coupled metals. The use of electrochemical impedance spectroscopy includes exposing the coupled metals to the electrolyte 22. The electrolyte is 0.5 normal sodium chloride. In addition, the ratio of the surface area of the first metal 18 exposed to the electrolyte 22 to the surface area of the second metal exposed to the electrolyte is about 3:1. After the coupled metals are placed in contact with the electrolyte 22, the coupled metals are exposed to a known current that is passed through the electrolyte. The current is preferably a small, sinusoidal, variable frequency, potentiostat-generated voltage.

The current received at the coupled metals is then monitored. The monitored and collected data are then plotted, and the coupled metal plot is matched to a known plot for a given physical circuit. The corrosion rates associated with the matched plot are used to determine corrosion rates for the coupled metals.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. A method for determining the corrosion rates of galvanically coupled metals, said method comprising the steps of:
coupling two dissimilar metals;
using electrochemical impedance spectroscopy to produce a plot of impedance and phase angle verses frequency for the coupled metals;
matching the coupled metal plot to a known plot for a given physical circuit; and
determining corrosion rates for the coupled metals based on corrosion rates associated with the matched plot.

2. The method of claim 1, wherein said step of coupling two dissimilar metals further comprises:
forming an aperture in a first metal; and
filling the aperture with a second metal.

3. The method of claim 2, wherein at least one of the first metal and the second metal is substantially more anodic.

4. The method of claim 2, wherein said step of forming the aperture includes the aperture with a substantial circular cross-section.

5. The method of claim 2, wherein said step of using electrochemical impedance spectroscopy further comprises exposing the coupled metals to an electrolyte and the ratio of the surface area of the first metal exposed to the electrolyte to the surface area of the second metal exposed to the electrolyte is in a ratio of 3:1.

6. The method of claim 5, wherein the electrolyte comprises 0.5 normal sodium chloride.

7. The method of claim 1, wherein said step of coupling the two metals further comprises galvanically coupling the metals.

8. The method of claim 1, wherein said step of coupling the two metals comprises coupling mild steel and aluminum.

9. The method of claim 1, wherein said step of coupling the two metals comprises coupling mild steel and stainless steel.

10. The method of claim 1, wherein said step of coupling the two metals comprises coupling stainless steel and aluminum.

11. The method of claim 1, further comprising a step of coating the coupled metals with at least one corrosion resistant material.

12. The method of claim 1, wherein said step of using electrochemical impedance spectroscopy further comprises:
placing the coupled metals in contact with an electrolyte;
exposing the coupled metals to a known current; and
monitoring the current at the coupled metals.

13. The method of claim 12, wherein the electrolyte comprises 0.5 normal sodium chloride.

14. The method of claim 12, wherein said step of exposing the coupled metals to a known circuit comprises exposing the coupled metals to a sinusoidal, variable frequency and potentiostat-generated voltage.
